(19) United States
(12) Patent Application Publication
(10) Pub. No.: US 2014/0154920 A1
(43) Pub. Date: Jun. 5, 2014

(54) CHOKE COIL DEVICES AND METHODS OF MAKING AND USING THE SAME

(71) Applicant: Pulse Electronics, Inc., (US)

(72) Inventors: Thuyen Dinh, San Diego, CA (US); Mohammad Saboori, San Diego, CA (US); Aurelio Gutierrez, Bonita, CA (US); Hamlet Abedmamoore, San Diego, CA (US)

(21) Appl. No.: 13/835,217

(22) Filed: Mar. 15, 2013

Related U.S. Application Data
(60) Provisional application No. 61/732,698, filed on Dec. 3, 2012.

(51) Int. Cl. H01F 17/02; H01F 41/06; H01R 13/66

(52) U.S. Cl. CPC H01F 17/02; H01R 13/6633; H01F 41/0625
USPC 439/620.01; 336/208; 29/605

(57) ABSTRACT

A chip choke assembly which reduces the loss of magnetic flux from the underlying core portions. In one embodiment, this reduction is achieved by producing a chip choke assembly comprised of two or more chip choke portions that collectively form a closed magnetic path. Additionally, the chip choke assembly disclosed herein also allows for adequate clearance between adjacent pads so as to avoid arcing during high potential voltage conditions. Methods for manufacturing and using the aforementioned chip choke assembly are also disclosed.

### PRIORITY

This application claims the benefit of priority to co-owned U.S. Provisional Patent Application Ser. No. 61/732,698 of the same title filed Dec. 3, 2012, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNOLOGICAL FIELD

The present disclosure relates generally to the area of electronic assemblies, and more specifically in one exemplary aspect to an improved design for providing a surface mountable wire wound chip inductor, and methods of manufacturing and using the same.

### 2. DESCRIPTION OF RELATED TECHNOLOGY

Traditionally, so-called “chip chokes” are made by automatically winding magnet wires on cores having a rectangular prism shape. A column or pillar core section is also known that has flange sections on both ends. The winding is wound around the core axial section, with both ends of the winding fixed to electrodes provided on the flange sections to make the chip choke assembly surface-mountable. However, such core shapes do not fully contain the magnetic flux in the core (i.e., are “open”), and the resultant inductance is of several orders lower than that of cores with a closed magnetic path, such as a magnetically permeable toroid.

Furthermore, transformers that use other shaped cores (such as EE, EP, Pot cores, etc.) are wound on a plastic bobbin, and the core is inserted around this bobbin. Such a construction is typically used in lower frequency applications because of the rather high flux leakage, caused in part by the rather large core shapes. In higher frequency applications (i.e., applications with frequency components in the Gigahertz (GHz) range, such as those seen in 1 Gbps and 10 Gbps Ethernet), these traditional core shapes and winding techniques do not work, because of the reduced bandwidth associated with these shapes.

In traditional prior art integrated connector module (ICM) applications, such as for example that disclosed in co-owned U.S. Pat. No. 7,241,181 filed on Jun. 28, 2005 and entitled “Universal Connector Assembly and Method of Manufacturing”, the contents of which are incorporated herein by reference in its entirety, choke coils are manufactured using prior art toroid cores. Such choke coils fully contain the magnetic flux within the core, thereby increasing the desirable characteristics of the device (e.g. inductance). More recently, improved inductive apparatus and methods for manufacturing and utilizing the same have been developed. One example of this is disclosed in co-owned and co-pending U.S. patent application Ser. No. 12/876,003 filed Sep. 3, 2010 and entitled “Substrate Inductive Devices and Methods”, the contents of which are incorporated herein by reference in its entirety, which discloses a substrate-based inductive device that in one exemplary embodiment utilizes inserted conductive pins in combination with plated substrates to replace traditional windings disposed around a magnetically permeable core. These substrate-based inductive devices can then be utilized in applications such as, for example, integrated connector modules. These substrate inductive devices also utilize toroid cores for their choke inductors; however, issues such as conductive anodic filament (CAF) (e.g., where a copper conductive filament forms in the dielectric material between two adjacent conductors under an electrical bias) have become problematic in applications where a large number of toroid cores (including choke coils) have been used in an otherwise fixed space.

Therefore, conventional chip chokes and shaped core choke coils do not have enough inductance and/or possess too much flux leakage to be used in these high speed integrated connector module applications, while traditional toroid choke coils are bulky and do not meet the demands of component miniaturization to address issues such as CAF in designs that incorporate substrate-based inductive device applications. Accordingly, there remains an unsatisfied need for an improved choke coil, preferably that can be: (1) surface mounted; (2) which can reduce magnetic flux loss; (3) reduce overall size as compared with traditional toroid core designs; and (4) has excellent electrical properties such as high Q, and high reliability.

### SUMMARY

The present disclosure satisfies the aforementioned needs by providing, inter alia, an improved chip choke apparatus and methods for manufacturing and using the same.

In a first aspect, an exemplary chip choke apparatus is disclosed. In one embodiment, the chip choke apparatus includes a two piece chip choke where the individual pieces are held together with a metallic clip to form an I-shaped chip choke that reduces the loss of magnetic flux seen in prior art chip chokes.

In another embodiment, the individual pieces of the two piece chip choke are held together with a metallic clip to form a square shaped chip choke which also reduces the loss of magnetic flux.

In another embodiment, the chip choke assembly includes a first chip choke portion having a first plurality of windings disposed about a first axial section of said first chip choke portion; and a second chip choke portion having a second plurality of windings disposed about a first axial section of said second chip choke portion. The first chip choke portion and the second chip choke portion collectively form a closed magnetic path for the chip choke assembly.

In the second aspect, methods of manufacturing the aforementioned chip choke apparatus are disclosed. In one embodiment, the method includes providing a pair of core portions, each of the core portions including an axial portion and a pair of flange portions; attaching a printed circuit board to each of the flange portions; winding each of the core portions with a plurality of windings; attaching ends of the windings to a respective one of the printed circuit boards; and holding the pair of core portions together to form the chip choke assembly.

In a third aspect, methods of using the aforementioned chip choke apparatus are disclosed. In one embodiment, the chip choke apparatus is utilized in integrated connector module (ICM) applications which utilize substrate based inductive devices thereby improving the amount of space available to address issues such as CAF.

In a fourth aspect, a technique for reducing or eliminating CAF is disclosed.

In a fifth aspect, an integrated connector module is disclosed. In one embodiment, the integrated connector module includes a connector housing and a plurality of magnetic components disposed within the connector housing, the plurality of magnetic components, include wound ferrite cores; and a chip choke assembly. The chip choke assembly includes a first chip choke portion having a first plurality of windings disposed about a first axial section of said first chip choke portion; and a second chip choke portion comprising a second plurality of windings disposed about a first axial section of said second chip choke portion. The first chip choke portion and the second chip choke portion collectively form a closed magnetic path for the chip choke assembly.

### BRIEF DESCRIPTION OF THE DRAWINGS

The features, objectives, and advantages of the disclosure will become more apparent from the detailed description set forth below taken in conjunction with the drawings, wherein:

FIGS. 1A-1F illustrate various views of one exemplary embodiment of a chip choke apparatus in accordance with the principles of the present disclosure.

FIGS. 2A-2B illustrate various views of an alternative embodiment of a chip choke apparatus in accordance with the principles of the present disclosure.

FIG. 3 is an exemplary process flow diagram illustrating on exemplary embodiment for manufacturing the chip choke illustrated in FIGS. 1A-1F and 2A-2B.

FIGS. 4A-4B is an exemplary embodiment illustrating the use of the chip choke apparatus of FIGS. 1A-1F on the surface of a printed circuit board.

### DETAILED DESCRIPTION

Reference is now made to the drawings, wherein like numerals refer to like parts throughout.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “magnetically permeable” refers to any number of materials commonly used for forming inductive cores or similar components, including without limitation various formulations made from ferrite.

As used herein, the term “signal conditioning” or “conditioning” shall be understood to include, but not be limited to, signal voltage transformation, filtering and noise mitigation, signal splitting, impedance control and correction, current limiting, capacitance control, and time delay.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

In one aspect, an improved chip choke assembly is disclosed which reduces the loss of magnetic flux from the underlying core design by incorporating two or more chip choke portions that collectively form a closed magnetic path.

In one embodiment, the present disclosure addresses conductive anodic filament (CAF) issues with so-called substrate inductive devices that occur under certain conditions. These conditions include high humidity, high bias voltage (i.e. a large voltage differential), high-moisture content, surface and resin ionic impurities, glass to resin bond weakness, and exposure to high assembly temperatures that can occur, for example, during lead-free solder bonding application.

Furthermore, the improved chip choke assembly disclosed herein is designed to achieve higher inductance levels in a smaller size chip choke assembly thereby enabling more room to accommodate extra spacing between, for example, conductive vias. This extra room results in the elimination of issues with CAF, while providing a design that offers improved electrical performance over prior art chip choke inductors.

The exemplary chip choke assembly embodiments disclosed herein also allow for adequate clearance between adjacent pads of adjacent windings of the chip choke portions, so as to avoid arcing during high-potential voltage conditions. This enables, inter cilia, ready implementation of the chip choke assembly into existing designs by complying with most data communication standards.

Additional features are also optionally provided which facilitate the automated use and installation of these aforementioned chip choke assemblies.

Furthermore, methods for manufacturing and using these aforementioned chip choke assemblies are also disclosed.

### DETAILED DESCRIPTION OF EXEMPLARY EMBODIMENTS

It will be recognized that while the following discussion is cast in terms of an exemplary two piece chip choke assembly, it would be readily apparent to one of ordinary skill given the present disclosure that same principles apply for chip choke assemblies that use more than two pieces. For example, it is envisioned that in certain embodiments, a chip choke assembly can be composed of three (3) or more core pieces, with one (1) of these core pieces used for the choke coil and the remaining two (2) core pieces being utilized for a traditional transformer arrangement.

Furthermore, it would be readily apparent to one of ordinary skill given the present disclosure that same principles apply for chip choke assemblies irrespective of whether or not the individual chip choke pieces and/or winding configurations are identical or different from each other. For example, in an exemplary chip choke assembly that utilizes three (3) core pieces, it is envisioned that two (2) of the these core pieces might be identical in size, while the third core piece might be larger or smaller than these two (2) other core pieces. Alternately, three heterogeneous core pieces and/or windings may be utilized. These and other variants of multiple chip choke embodiments would be readily apparent to one of ordinary skill given the present disclosure.

### Exemplary Mechanical Configuration—

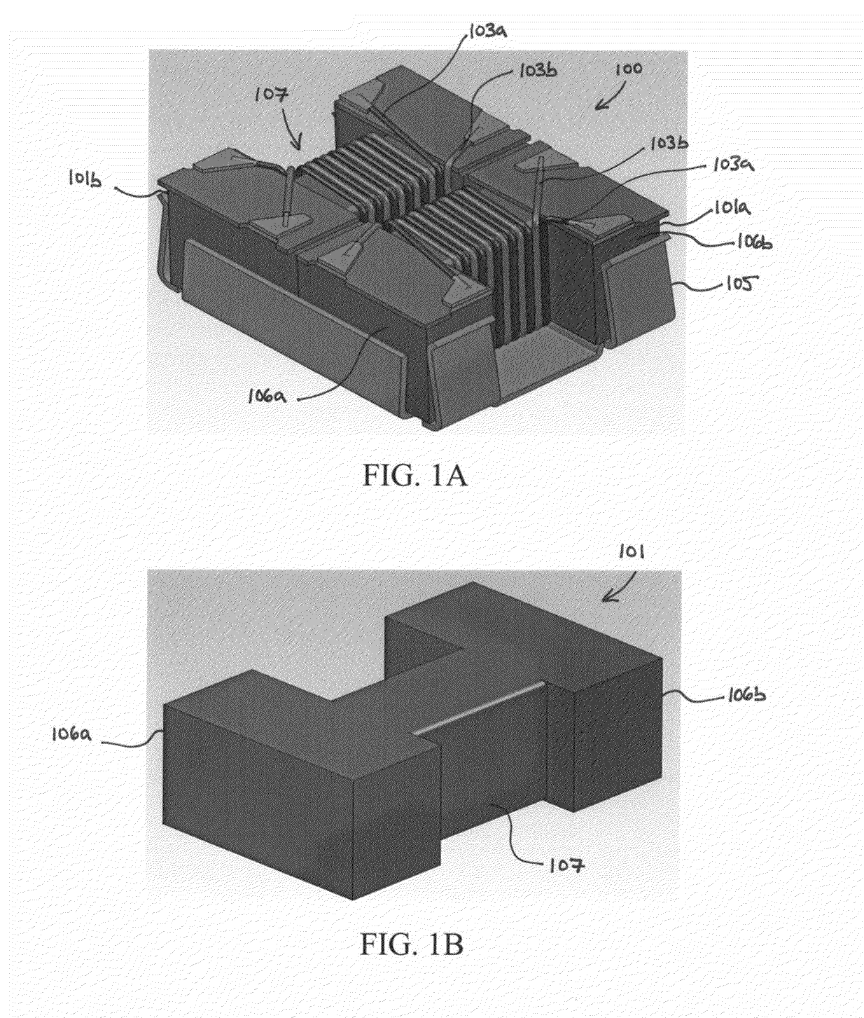

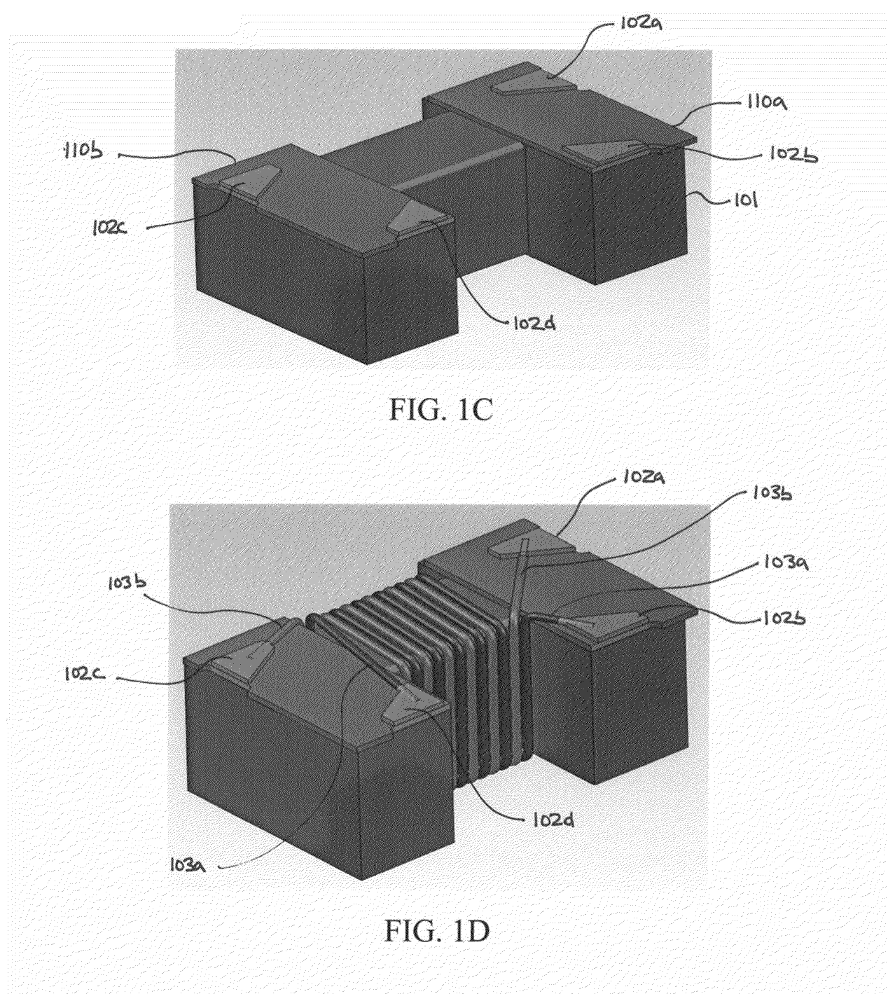

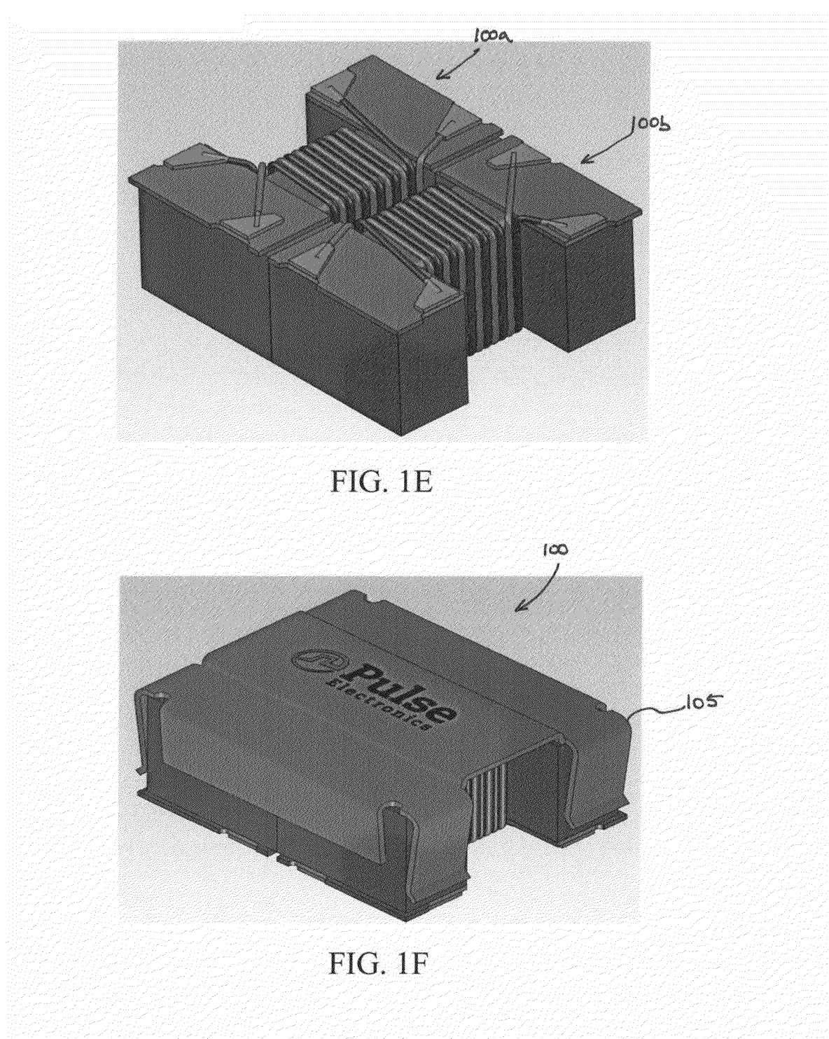

Referring now to FIG. 1A, a first exemplary embodiment of a chip choke assembly 100 in accordance with the principles of the present disclosure is shown and described in detail. The chip choke assembly comprises two separate skewed I-shaped chip choke core portions 101a and 101b held together in the illustrated embodiment with a metallic clip 105 to form the chip choke assembly 100. As can be seen from FIG. 1A, the chip choke assembly is shaped so as to resemble the English capital letter “I”. The chip choke assembly 100 illustrated comprises two (2) chip choke core portions 101, each comprising a single axial portion 107 and two flange portions 106a and 106b at either end thereof. Each chip choke core portion is wound, in the illustrated embodiment, with two (2) windings 103a and 103b using existing automatic winding processes with standard magnet wires. Accordingly, the chip choke assembly 100 will in the illustrated embodiment have a total of four (4) windings (i.e. two (2) on core portion 101a and two (2) on core portion 101b) disposed on the axes 107 of the chip choke assembly 100. The two (2) chip choke portions also collectively form an I-shaped core structure where the flange portions 106a and 106b form a closed magnetic system with the opposing arms of the adjacent chip choke core portion, thereby significantly reducing the loss of magnetic flux as compared with a traditional rectangular prism shaped chip choke as is present in the prior art. As discussed previously, this reduction in the loss of magnetic flux is extremely useful in, inter alia, high frequency designs (e.g. 1 Gbps and 10 Gbps Ethernet applications). The core shape for the chip choke portions 101a and 101b is designed so as to minimize the mean magnetic path length to achieve a higher inductance level in a smaller size. Additionally, such a design minimizes magnetic flux leakage to yield a wider operating bandwidth.

Referring now to FIGS. 1B-1D, the individual chip choke portions 101 are described in greater detail. FIG. 1B illustrates a ferrite core used in the manufacture of the individual chip choke portions. While the use of a ferrite core is exemplary, other common core materials can be used (such as laminated silicon steel, etc.) to achieve the desired electrical performance characteristics of the chip choke assembly. The ferrite core of the present embodiment has an axial part 107 and two flange sections 106a and 106b disposed on each end of the axial part 107 such that the core 101 is in the shape of a skewed-I as shown in FIG. 1B. While the skewed I-shape is exemplary, other suitable alternative shapes may be substituted consistent with the final objective of reducing the loss of magnetic flux. For example, square shaped cores, “C”-shaped cores and “C” and “I” shaped cores could be substituted as well.

FIG. 1C illustrates the enhancement of the core for use in the individual chip choke pieces 101 illustrated in, for example, FIG. 1A. Specifically, the flange sections 106a and 106b are optionally coated with an isolation barrier such as a ceramic coating 110. Miniature circuit board substrates 110a and 110b (e.g. PCBs) are subsequently mounted onto the bottom portion of the chip choke core piece 101. These circuit board substrates incorporate pads (102a, 102b, 102c and 102d) that are placed in each of the four (4) corners of the substrate. By placing each of these circuit board substrate pads in opposing corners, i.e. so that two (2) of these pads are disposed adjacent to the axial portion 107 while the other two (2) are disposed away from the axial portion, this allows for adequate clearance between the pads for the two (2) windings thereby avoiding high-potential arcing which is a requirement for most data communication standards, as discussed previously above.

Referring now to FIG. 1D, one half of the finished chip choke assembly illustrated in FIG. 1A is illustrated and described in detail. Specifically, FIG. 1D illustrates the windings 103a and 103b wound onto the axial section of the core with the ends of the windings 103a and 103b fixed to the aforementioned miniature PCB pads on the upper face of the flange portions of the ferrite core via resistance welding. While the use of resistance welding is exemplary, the use of conductive adhesives, solder and the like could readily be substituted. As shown, winding 103a is disposed onto the inner pads 102b and 102d while the other winding 103b is disposed onto the outer pads 102a and 102c. Such a configuration is exemplary in that the finished wire length for windings 103a and 103b are essentially the same in such a configuration. FIGS. 1E and 1F illustrate the final chip choke assembly 100 formed by placing the two individual chip choke pieces 100a and 100b together and subsequently holding them together via the use of a metallic clip 105. While the use of a metallic clip is exemplary, other techniques such as the use of well-known epoxy adhesives can be readily substituted to hold the two individual chip choke pieces together.

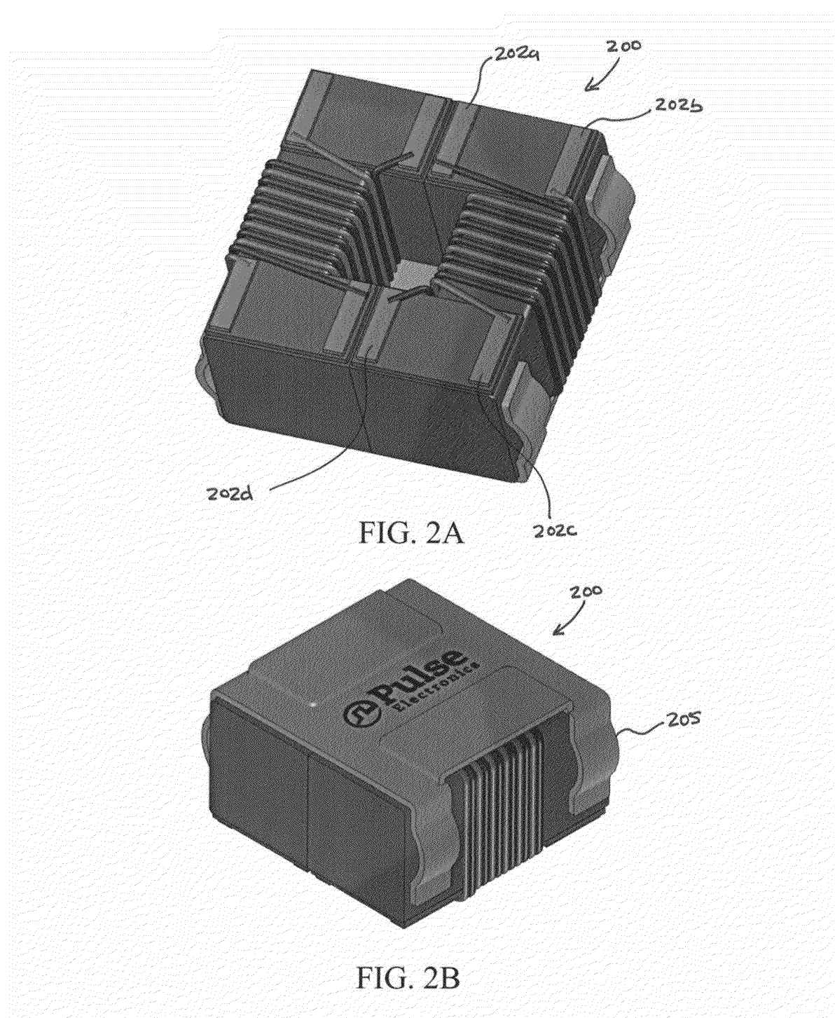

FIGS. 2A and 2B illustrate an alternative embodiment to the chip choke assembly 100 illustrated in FIG. 1A. Specifically, FIG. 2A illustrates a chip choke assembly 200 in which the core pieces are arranged so that the core pieces form a rectangular-shape (as opposed to the “I” shape illustrated previously). Such a configuration has advantages in that a rectangular-shape provides additional room for wire termination and for soldering the wires to the terminals. In addition, the pads 202a, 202b, 202c and 202d are illustrated with a configuration in which each of the pads extends across the width of the flange section of the core. FIG. 2B illustrates the metal clip 205 used to hold the two portions together thereby resulting in the chip choke assembly 200 as it is to be used in practice.

### Methods of Manufacture

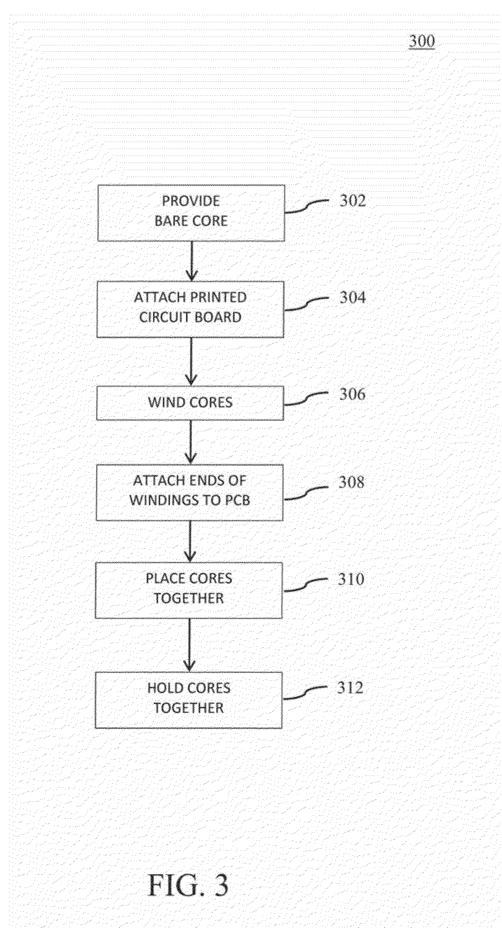

Exemplary methods of manufacture and use of the chip choke assembly according to the principles of the present disclosure are now described in detail. Referring to FIG. 3, a first exemplary method for manufacturing 300 the aforementioned chip choke assembly is described in detail. At step 302, a first core of the desired material is shaped into the desired shape. In one embodiment, the core is a skewed I-shaped core of the type illustrated in FIG. 1B. The core thus has an axial portion and 2 flanges disposed on both ends of the axial portion. As discussed previously, it will be readily apparent to those skilled in the art without departing from the present disclosure that another shape may be used as required for the final desired shape and properties of the chip choke assembly.

At step 304, the core of step 302 has printed circuit boards (PCBs) attached to the core portion of the chip choke assembly. In one embodiment, the core portion will comprise the I-shaped core portion having flange portions disposed on either side of an axial portion. In one embodiment, the insulating material used is a ceramic coating.

At step 306, coils are wound onto the core of step 304 using an automated winding process of the type known in the prior art. In one embodiment, the coils used are magnet wires and two (2) windings are wound around the axial portion of the core piece.

At step 308, the ends of each of the windings are attached to the pads located on the PCBs. In one embodiment, a resistance welding technique is used to secure the end of the windings to the PCB although it is envisioned that adhesives, solder, etc. can readily be substituted in place of the exemplary resistance welding technique discussed.

At step 310, two individual chip choke cores that are wound at step 308 are placed together to form the desired shape of the final chip choke assembly. In one exemplary embodiment, the chip choke assembly is shaped as English letter “I” and is formed by putting together two (2) individual skewed “I” shaped chip chokes. In another embodiment, the chip choke assembly is square shaped. In yet another embodiment, three (3) or more core portions are assembled into a single chip choke assembly. While the use of the “I” shape and square shape are exemplary, other shapes may be formed to get the desired magnetic flux and electrical properties without deviating from the principles of the present disclosure.

At step 312, the individual chip chokes are held together. In one embodiment, the individual chip chokes are held in place via the use of a clip to form, for example, the final chip choke assembly 100 of FIG. 1A. In an alternative embodiment, the cores can be held together using an epoxy adhesive.

### Methods of Use

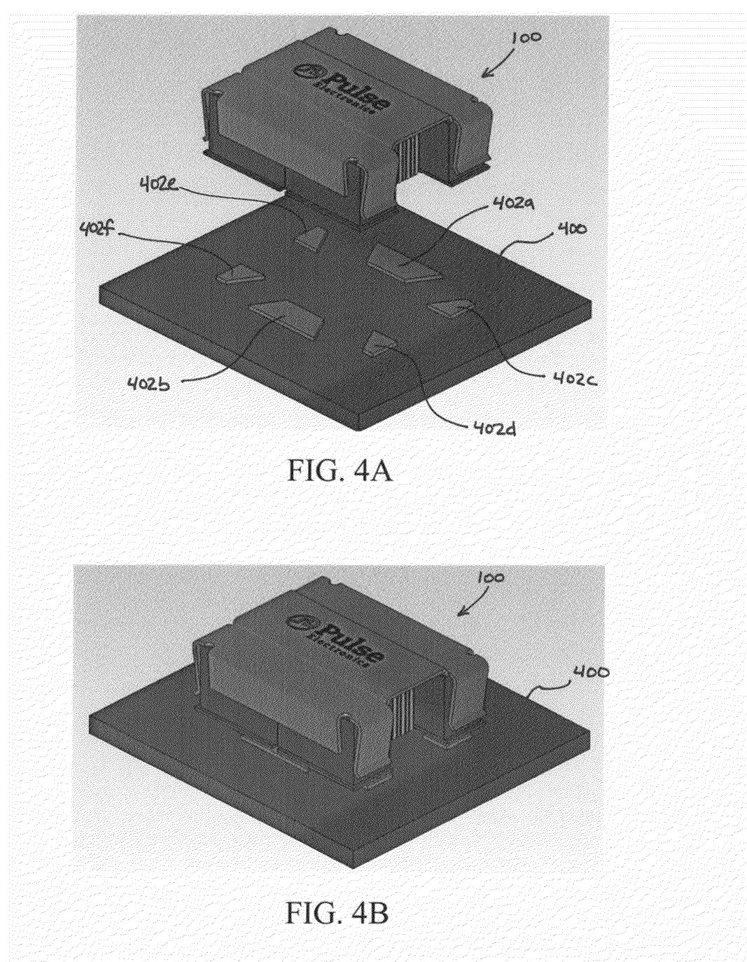

Referring now to FIGS. 4A-4B, a first exemplary method of using the chip choke assembly of the disclosure is shown and described in detail. FIG. 4A illustrates the installation of the chip choke assembly 100 on a prefabricated PCB 400 to complete the connections to form the mounted chip choke assembly of FIG. 4B. Specifically, and as illustrated in FIG. 4A, pads 402a and 402b located on substrate 400 are used to attach the outer pads (102a and 102c, FIG. 1D) to the substrate. The inner pads of the substrate (402c, 402d, 402e and 402f) are used to connect to the inner pads (102b and 102d, FIG. 1D) of the chip choke assembly.

It will be recognized that while certain aspects of the disclosure are described in terms of specific design examples, these descriptions are only illustrative of the broader methods, and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claims herein.

While the above detailed description has shown, described, and pointed out novel features of the disclosure as applied to various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles of the disclosure, the scope of which should be determined with reference to the claims.

What is claimed is:

1. A chip choke assembly, comprising:
a first chip choke portion comprising a first plurality of windings disposed about a first axial section of said first chip choke portion; and
a second chip choke portion comprising a second plurality of windings disposed about a first axial section of said second chip choke portion;
wherein the first chip choke portion and the second chip choke portion collectively form a closed magnetic path for the chip choke assembly.

2. The chip choke assembly of claim 1, wherein the first chip choke portion comprises a skewed I-shaped portion having a first pair of flange elements.

3. The chip choke assembly of claim 2, wherein the second chip choke portion comprises a skewed I-shaped portion having a second pair of flange elements.

4. The chip choke assembly of claim 3, wherein the first and second chip choke portions are arranged such that a small dimension of the first and second pair of flange elements are positioned such that they are adjacent one another.

5. The chip choke assembly of claim 3, wherein the first and second chip choke portions are arranged such that a large dimension of the first and second pair of flange elements are positioned such that they are adjacent one another.

6. The chip choke assembly of claim 3, further comprising a plurality of termination pads, the termination pads being resident on opposing corners of the chip choke assembly.

7. The chip choke assembly of claim 6, further comprising a metallic clip that is configured to join the first and second chip choke portions to tone another.

8. The chip choke assembly of claim 6, wherein the first chip choke portion and the second chip choke portion collectively forming a closed magnetic path is useful for a high frequency application.

9. The chip choke assembly of claim 8, wherein the high frequency application consists of: (1) a 1 Gbps Ethernet application; and (2) a 10 Gbps Ethernet application.

10. An integrated connector module, comprising:
a connector housing and a plurality of magnetic components disposed within the connector housing, the plurality of magnetic components, comprising:
a plurality of wound ferrite cores; and
a chip choke assembly, comprising:
a first chip choke portion comprising a first plurality of windings disposed about a first axial section of said first chip choke portion; and
a second chip choke portion comprising a second plurality of windings disposed about a first axial section of said second chip choke portion;
wherein the first chip choke portion and the second chip choke portion collectively form a closed magnetic path for the chip choke assembly.

11. The integrated connector module of claim 10, wherein the use of the chip choke assembly in the plurality of magnetic components enables larger size wound ferrite cores to be used than would be possible without the use of the chip choke assembly.

12. The integrated connector module of claim 11, wherein the plurality of wound ferrite cores comprise a plurality of substrate inductive devices with the enabling of the larger size wound ferrite core minimizing conductive anodic filament (CAF) development within the substrate inductive devices.

13. The integrated connector module of claim 10, wherein the plurality of magnetic components and the closed magnetic path for the chip choke assembly are configured for a high frequency application.

14. The integrated connector module of claim 13, wherein the high frequency application consists of: (1) a 1 Gbps Ethernet application; and (2) a 10 Gbps Ethernet application.

15. The integrated connector module of claim 10, wherein the first chip choke portion comprises a skewed I-shaped portion having a first pair of flange elements.

16. The integrated connector module of claim 15, wherein the second chip choke portion comprises a skewed I-shaped portion having a second pair of flange elements.

17. The integrated connector module of claim 16, wherein the first and second chip choke portions are arranged such that a small dimension of the first and second pair of flange elements are positioned such that they are adjacent one another.

18. The integrated connector module of claim 16, wherein the first and second chip choke portions are arranged such that a large dimension of the first and second pair of flange elements are positioned such that they are adjacent one another.

19. A method of manufacturing a chip choke assembly, comprising:
providing a pair of core portions, each of the core portions comprised of an axial portion and a pair of flange portions;
attaching a printed circuit board to each of the flange portions;
winding each of the core portions with a plurality of windings;
attaching ends of the windings to a respective one of the printed circuit boards; and
holding the pair of core portions together to form the chip choke assembly.

20. The method of manufacturing the chip choke assembly of claim 19, wherein the act of holding the pair of core portions together comprises securing the pair of core portions together with a metallic clip.
